(19) United States
(12) Patent Application Publication
(10) Pub. No.: US 2026/0350165 A1
(43) Pub. Date: Nov. 5, 2026

(54) Subtraction forests for generating robust rules for identifying malicious code segments

(71) Applicant: Palo Alto Networks, Inc., Santa Clara, CA (US)

(72) Inventors: Yinnon Hertzel Meshi, Kibbutz Revivim (IL); Eran Tamari, Kfar Saba (IL); Gal Itzhak, Holon (IL); Niv Sela, Kfar Saba (IL)

(21) Appl. No.: 19/194,003

(22) Filed: Apr. 30, 2025

(51) Int. Cl. G06F 21/56

(52) U.S. Cl. CPC G06F 21/566

(57) ABSTRACT

A method for defining rules for identifying malicious code segments based on their features includes training multiple decision trees, including an initial decision tree and one or more additional decision trees, on a training set of code-segment samples, some of which are malicious, the decision trees including multiple leaf nodes corresponding to different respective conditions on the features, by training the initial decision tree and then sequentially training each additional decision tree while excluding, from the code-segment samples, at least some of the features used by those of the decision trees already trained, identifying, from among the leaf nodes, one or more malicious-class leaf nodes that correspond to a malicious class and satisfy at least one predefined criterion, and defining the rules based on the conditions corresponding to the identified malicious-class leaf nodes. Other embodiments are also described.

### CROSS-REFERENCE TO RELATED APPLICATIONS

The present application is related to the following applications filed on even date herewith: (i) Spawned decision trees for generating robust rules for identifying malicious code segments (attorney ref. no. 601188/2043); (ii) Semi-supervised approach for tightening rules for identifying malicious code segments (attorney ref. no. 601188/2044); and (iii) Semi-supervised approach for selecting rules for identifying malicious code segments (attorney ref. no. 601188/2045).

### FIELD OF EMBODIMENTS OF THE INVENTION

Embodiments of the present invention are related generally to the field of cybersecurity, and particularly to the identification of malicious code segments.

### BACKGROUND

Yet Another Recursive Acronym (YARA) is an open-source tool primarily used for identifying and classifying malware through pattern matching. It enables security researchers and incident responders to create custom rules to detect specific strings, byte sequences, or other characteristics within files, memory, or network traffic. These rules, written in a simple syntax, allow for a flexible approach to detecting known threats based on their unique patterns or behaviors. YARA is widely used in malware analysis, digital forensics, and threat hunting to identify malicious artifacts, track ongoing threats, and automate the detection of suspicious activity across large datasets. Its powerful capabilities make it an important tool in proactive cybersecurity measures.

Some malware utilizes a piece of shellcode, which is a small, specialized piece of position-independent code unmapped to disk. Some types of shellcode are designed to exploit vulnerabilities in a computer system or application, typically in the context of a security attack. For example, some shellcode is used in buffer overflow attacks to gain control over a target machine, executing commands or programs that the attacker desires. Other types of shellcode, referred to as post-exploitation shellcode, are executed by attackers after gaining initial access to a compromised system. This type of shellcode is not designed to gain access but rather to maintain persistence, escalate privileges, extract data, pivot within a network, or perform any other operation intended to be hidden from monitoring tools. Shellcode usually takes the form of machine-level instructions that can be injected into a process's memory, bypassing security mechanisms like firewalls or intrusion detection systems. Once executed, it may open a command shell, allowing the attacker to execute arbitrary code, escalate privileges, or even take full control of the system. Despite its name, shellcode doesn't always involve a shell; it can refer to any type of payload intended to compromise a target system.

A decision tree is a model that makes decisions based on a series of binary splits in the data, leading to a tree-like structure where each leaf node represents a predicted outcome. A decision forest is a model comprising multiple decision trees.

### SUMMARY

There is provided, in accordance with some embodiments of the present invention, a system, including a memory configured to store program instructions for defining multiple rules for identifying malicious code segments based on features of the code segments, and a processor. The processor is configured to, by executing the program instructions, perform a process that includes training multiple decision trees, including an initial decision tree and one or more additional decision trees, on a training set of code-segment samples, some of which are malicious, the decision trees including multiple leaf nodes corresponding to different respective conditions on the features such that each of the code-segment samples assigned to any one of the leaf nodes satisfies the condition corresponding to the leaf node, by training the initial decision tree, and subsequently to training the initial decision tree, sequentially training each additional decision tree while excluding, from the code-segment samples, at least some of the features used by those of the decision trees already trained. The process further includes identifying, from among the leaf nodes, one or more malicious-class leaf nodes that correspond to a malicious class and satisfy at least one predefined criterion, and defining the rules based on the conditions corresponding to the identified malicious-class leaf nodes.

There is further provided, in accordance with some embodiments of the present invention, a method for defining multiple rules for identifying malicious code segments based on features of the code segments. The method includes training multiple decision trees, including an initial decision tree and one or more additional decision trees, on a training set of code-segment samples, some of which are malicious, the decision trees including multiple leaf nodes corresponding to different respective conditions on the features such that each of the code-segment samples assigned to any one of the leaf nodes satisfies the condition corresponding to the leaf node, by training the initial decision tree, and subsequently to training the initial decision tree, sequentially training each additional decision tree while excluding, from the code-segment samples, at least some of the features used by those of the decision trees already trained. The method further includes identifying, from among the leaf nodes, one or more malicious-class leaf nodes that correspond to a malicious class and satisfy at least one predefined criterion, and defining the rules based on the conditions corresponding to the identified malicious-class leaf nodes.

In some embodiments, the rules are Yet Another Recursive Acronym (YARA) rules.

In some embodiments, the rules are for identifying shellcode.

In some embodiments, the predefined criterion includes a minimum number of assigned malicious code-segment samples.

In some embodiments, the predefined criterion includes a minimum percentage of assigned code-segment samples that are malicious.

In some embodiments, training the decision trees includes training at least one forest, which includes at least some of the decision trees, by:
training a first decision tree t₁ of the forest, and
training subsequent decisions trees {t₂, . . . , t_{N}} of the forest, by, for k=2 . . . N:
   identifying a subset Rₖ₋₁ of the features that is used by tₖ₋₁, and
   training tₖ while excluding

$${⋃}_{j = 1}^{k - 1} {R}_{j}$$

from each of the code-segment samples.

In some embodiments, identifying the subset Rₖ₋₁ includes identifying those of the features that are more important to tₖ₋₁ than are others of the features.

In some embodiments, the subset Rₖ₋₁ of the features includes all the features used by tₖ₋₁.

In some embodiments, defining the rules includes:
identifying multiple different subsets of the conditions corresponding to those of the identified malicious-class leaf nodes in the forest, each of the subsets including no more than one of the conditions from any given one of the decision trees in the forest; and
for each of the subsets, defining a respective rule that includes all the conditions in the subset.

In some embodiments, training the decision trees includes training M>1 forests {f₁, . . . , f_{M}}, each of which includes one or more of the decision trees, by:
training f₁; and
for i=2 . . . M:
   identifying a subset Qᵢ₋₁ of the features that is used by fᵢ₋₁, and
   training fᵢ while excluding

$${⋃}_{j = 1}^{i - 1} {Q}_{j}$$

from each of the code-segment samples.
In some embodiments, identifying the subset Qᵢ₋₁ includes identifying those of the features that are more important to fᵢ₋₁ than are others of the features.

In some embodiments, identifying the subset Qᵢ₋₁ includes identifying a predefined number of the features having greatest importance to each of the decision trees in fᵢ₋₁.

In some embodiments, identifying the malicious-class leaf nodes and defining the rules includes, for each one of the forests:
identifying those of the malicious-class leaf nodes in the forest that satisfy the at least one predefined criterion; and
defining one or more of the rules based on the conditions corresponding to the identified malicious-class leaf nodes in the forest but not based on the conditions corresponding to the identified malicious-class leaf nodes in any other one of the forests.

There is further provided, in accordance with some embodiments of the present invention, a computer software product including a tangible non-transitory computer-readable medium in which program instructions are stored. The instructions, when read by a processor, cause the processor to define multiple rules for identifying malicious code segments based on features of the code segments, by performing a process including training multiple decision trees, including an initial decision tree and one or more additional decision trees, on a training set of code-segment samples, some of which are malicious, the decision trees including multiple leaf nodes corresponding to different respective conditions on the features such that each of the code-segment samples assigned to any one of the leaf nodes satisfies the condition corresponding to the leaf node, by training the initial decision tree, and subsequently to training the initial decision tree, sequentially training each additional decision tree while excluding, from the code-segment samples, at least some of the features used by those of the decision trees already trained. The process further includes identifying, from among the leaf nodes, one or more malicious-class leaf nodes that correspond to a malicious class and satisfy at least one predefined criterion, and defining the rules based on the conditions corresponding to the identified malicious-class leaf nodes.

There is further provided, in accordance with some embodiments of the present invention, a system, including a memory configured to store program instructions for defining multiple rules for identifying malicious code segments based on features of the code segments, and a processor. The processor is configured to, by executing the program instructions, perform a process that includes training, on a training set of code-segment samples, some of which are malicious, M≥1 forests {f₁, . . . , f_{M}} of decision trees including multiple leaf nodes corresponding to different respective conditions on the features such that each of the code-segment samples assigned to any one of the leaf nodes satisfies the condition corresponding to the leaf node, by, for each one of the forests, training an initial decision tree at a first level L₁ of the forest, and building levels {L₂, . . . , L_{N}} of the forest, by, for k=2 . . . N, identifying, from among the leaf nodes, one or more malicious-class leaf nodes in Lₖ₋₁ that correspond to a malicious class and satisfy at least one predefined criterion, and for each of the identified malicious-class leaf nodes, selecting a subset of the code-segment samples including at least some of the malicious code-segment samples assigned to the identified malicious-class leaf node, and spawning an additional decision tree at Lₖ from the identified malicious-class leaf node by training the additional decision tree on the subset of the code-segment samples while excluding, from each of the code-segment samples in the subset, those of the features used along a path from a top of the initial decision tree to the identified malicious-class leaf node. The process further includes, for each one of the forests, for each node s of at least some of the malicious-class leaf nodes in {L₂, . . . , L_{N}} satisfying at least one other predefined criterion, defining a respective one of the rules such that the rule includes a condition corresponding to the path from the top of the initial decision tree to s.

There is further provided, in accordance with some embodiments of the present invention, a method for defining multiple rules for identifying malicious code segments based on features of the code segments. The method includes training, on a training set of code-segment samples, some of which are malicious, M>1 forests {f₁, . . . , f_{M}} of decision trees including multiple leaf nodes corresponding to different respective conditions on the features such that each of the code-segment samples assigned to any one of the leaf nodes satisfies the condition corresponding to the leaf node, by, for each one of the forests training an initial decision tree at a first level L₁ of the forest, and building levels {L₂, . . . , L_{N}} of the forest, by, for k=2 . . . N, identifying, from among the leaf nodes, one or more malicious-class leaf nodes in Lₖ₋₁ that correspond to a malicious class and satisfy at least one predefined criterion, and for each of the identified malicious-class leaf nodes, selecting a subset of the code-segment samples including at least some of the malicious code-segment samples assigned to the identified malicious-class leaf node, and spawning an additional decision tree at Lₖ from the identified malicious-class leaf node by training the additional decision tree on the subset of the code-segment samples while excluding, from each of the code-segment samples in the subset, those of the features used along a path from a top of the initial decision tree to the identified malicious-class leaf node. The method further includes, for each one of the forests, for each node s of at least some of the malicious-class leaf nodes in {L₂, . . . , L_{N}} satisfying at least one other predefined criterion, defining a respective one of the rules such that the rule includes a condition corresponding to the path from the top of the initial decision tree to s.

In some embodiments, the rules are Yet Another Recursive Acronym (YARA) rules.

In some embodiments, the rules are for identifying shellcode.

In some embodiments, the subset of the code-segment samples further includes one or more benign code-segment samples assigned to one or more leaf nodes that branch from the path from the top of the initial decision tree to the identified malicious-class leaf node.

In some embodiments, the method includes defining a respective one of the rules for each of the malicious-class leaf nodes in {L₁, . . . , L_{N}} satisfying the other predefined criterion.

In some embodiments, the predefined criterion includes a minimum number of assigned malicious code-segment samples.

In some embodiments, the predefined criterion includes a minimum percentage of assigned code-segment samples that are malicious.

In some embodiments, the other predefined criterion includes a minimum number of assigned malicious code-segment samples.

In some embodiments, the other predefined criterion includes a minimum percentage of assigned code-segment samples that are malicious.

In some embodiments, training the forests includes:
training f₁; and
for i=2 . . . M:
   identifying a subset Qᵢ₋₁ of the features that is used by fᵢ₋₁, and
   training fᵢ while excluding

$${⋃}_{j = 1}^{i - 1} {Q}_{j}$$

from each of the code-segment samples.

In some embodiments, identifying the subset Qᵢ₋₁ includes identifying those of the features that are more important to fᵢ₋₁ than are others of the features.

In some embodiments, identifying the subset Qᵢ₋₁ includes identifying, for each of the decision trees in a top K levels of fᵢ₋₁, a predefined number of the features having greatest importance to the decision tree.

There is further provided, in accordance with some embodiments of the present invention, a computer software product including a tangible non-transitory computer-readable medium in which program instructions are stored. The instructions, when read by a processor, cause the processor to define multiple rules for identifying malicious code segments based on features of the code segments, by performing a process that includes training, on a training set of code-segment samples, some of which are malicious, M≥1 forests {f₁, . . . , f_{M}} of decision trees including multiple leaf nodes corresponding to different respective conditions on the features such that each of the code-segment samples assigned to any one of the leaf nodes satisfies the condition corresponding to the leaf node, by, for each one of the forests, training an initial decision tree at a first level L₁ of the forest, and building levels {L₂, . . . , L_{N}} of the forest, by, for k=2 . . . N, identifying, from among the leaf nodes, one or more malicious-class leaf nodes in Lₖ₋₁ that correspond to a malicious class and satisfy at least one predefined criterion, and for each of the identified malicious-class leaf nodes, selecting a subset of the code-segment samples including at least some of the malicious code-segment samples assigned to the identified malicious-class leaf node, and spawning an additional decision tree at Lₖ from the identified malicious-class leaf node by training the additional decision tree on the subset of the code-segment samples while excluding, from each of the code-segment samples in the subset, those of the features used along a path from a top of the initial decision tree to the identified malicious-class leaf node. The process further includes, for each one of the forests, for each node s of at least some of the malicious-class leaf nodes in {L₂, . . . , L_{N}} satisfying at least one other predefined criterion, defining a respective one of the rules such that the rule includes a condition corresponding to the path from the top of the initial decision tree to s.

There is further provided, in accordance with some embodiments of the present invention, a system, including a memory configured to store program instructions, and a processor. The processor is configured to, by executing the program instructions, obtain a rule for identifying malicious code segments, the rule including respective first conditions on one or more first features of the code segments, divide multiple code-segment samples into first samples and second samples such that the first conditions are satisfied more by the first samples than by the second samples, identify at least some of the second samples that are more similar to the first samples, relative to others of the second samples, identify one or more second features with respect to which the identified second samples differ from the first samples, add, to the rule, respective second conditions on the second features, such that the rule, even without the first conditions, would exclude at least some of the identified second samples by virtue of the second conditions, and store or communicate the rule for use in identifying malicious code segments.

There is further provided, in accordance with some embodiments of the present invention, a method including obtaining a rule for identifying malicious code segments, the rule including respective first conditions on one or more first features of the code segments, dividing multiple code-segment samples into first samples and second samples such that the first conditions are satisfied more by the first samples than by the second samples, identifying at least some of the second samples that are more similar to the first samples, relative to others of the second samples, identifying one or more second features with respect to which the identified second samples differ from the first samples, adding, to the rule, respective second conditions on the second features, such that the rule, even without the first conditions, would exclude at least some of the identified second samples by virtue of the second conditions, and storing or communicating the rule for use in identifying malicious code segments.

In some embodiments, the first samples include at least some of the code-segment samples identified, by the rule, as malicious, and the second samples include at least some of the code-segment samples identified, by the rule, as benign.

In some embodiments,
the first features include one or more binary features,
the first conditions include respective positive conditions on at least some of the binary features,
the first samples include at least some of the code-segment samples satisfying all the positive conditions, and
the second samples include at least some of the code-segment samples that do not satisfy all the positive conditions.

In some embodiments,
the first features include one or more binary features,
the first conditions include respective positive conditions on at least some of the binary features, and
the identified second samples include at least some of the second samples that satisfy at least one of the positive conditions.

In some embodiments, identifying the at least some of the second samples that are more similar to the first samples includes identifying at least some of the second samples whose distance from the first samples, per a distance measure, is less than a predefined threshold.

In some embodiments, identifying the second features includes identifying the second features such that each of the first samples satisfies the second conditions on the second features.

In some embodiments, identifying the second features includes identifying the second features using a maximum-coverage algorithm.

In some embodiments, the second features include one or more binary features, and the second conditions include respective negative conditions on the binary features.

In some embodiments, identifying the at least some of the second samples that are more similar to the first samples includes:
identifying a group of the second samples that are more similar to the first samples; and
reducing a size of the group.

In some embodiments, reducing the size of the group includes reducing the size of the group by randomly sampling from the group.

In some embodiments, the code-segment samples are associated with respective computing processes, and randomly sampling from the group includes:
dividing the group into smaller groups, each of which includes second samples associated with a different respective one of the computing processes; and
randomly sampling from the smaller groups.

There is further provided, in accordance with some embodiments of the present invention, a computer software product including a tangible non-transitory computer-readable medium in which program instructions are stored. The instructions, when read by a processor, cause the processor to obtain a rule for identifying malicious code segments, the rule including respective first conditions on one or more first features of the code segments, to divide multiple code-segment samples into first samples and second samples such that the first conditions are satisfied more by the first samples than by the second samples, to identify at least some of the second samples that are more similar to the first samples, relative to others of the second samples, to identify one or more second features with respect to which the identified second samples differ from the first samples, to add, to the rule, respective second conditions on the second features, such that the rule, even without the first conditions, would exclude at least some of the identified second samples by virtue of the second conditions, and to store or communicate the rule for use in identifying malicious code segments.

There is further provided, in accordance with some embodiments of the present invention, a system, including a memory configured to store program instructions for defining a set of rules for identifying malicious code segments based on features of the code segments, and a processor. The processor is configured to, by executing the program instructions, perform a process that includes applying a preliminary set of rules to multiple groups of code-segment samples having differing likelihoods of being malicious, each of the rules including one or more conditions on the features. The process further includes, for each one of the groups, computing respective counts for the rules, each of the counts being a number of the code-segment samples in the group that were identified, by a respective one of the rules, as malicious. The process further includes, for each of the rules, computing one or more possible-false-positive counts, which are respective numbers of samples belonging to respective subsets of the code-segment samples that were identified, by the rule, as malicious but have a lower likelihood of being malicious, relative to others of the code-segment samples. The process further includes reducing a size of the preliminary set, thereby defining the set, by removing, from the preliminary set, those of the rules for which at least one of the possible-false-positive counts exceeds a predefined threshold, and paring the rules in the preliminary set based on mutual similarity with respect to the conditions and the counts. The process further includes storing or communicating the set for use in identifying malicious code segments.

There is further provided, in accordance with some embodiments of the present invention, a method for defining a set of rules for identifying malicious code segments based on features of the code segments. The method includes applying a preliminary set of rules to multiple groups of code-segment samples having differing likelihoods of being malicious, each of the rules including one or more conditions on the features. The method further includes, for each one of the groups, computing respective counts for the rules, each of the counts being a number of the code-segment samples in the group that were identified, by a respective one of the rules, as malicious. The method further includes, for each of the rules, computing one or more possible-false-positive counts, which are respective numbers of samples belonging to respective subsets of the code-segment samples that were identified, by the rule, as malicious but have a lower likelihood of being malicious, relative to others of the code-segment samples. The method further includes reducing a size of the preliminary set, thereby defining the set, by removing, from the preliminary set, those of the rules for which at least one of the possible-false-positive counts exceeds a predefined threshold, and paring the rules in the preliminary set based on mutual similarity with respect to the conditions and the counts. The method further includes storing or communicating the set for use in identifying malicious code segments.

In some embodiments, the features include one or more binary features, the conditions include respective positive conditions on the binary features, and paring the rules includes paring the rules based on mutual similarity with respect to the positive conditions.

In some embodiments, at least one of the subsets includes those of the code-segment samples labeled as benign or as probably benign.

In some embodiments, one of the subsets includes those of the code-segment samples that are unlabeled.

In some embodiments, at least one of the groups is generated by at least one attack simulator.

In some embodiments, the rules are Yet Another Recursive Acronym (YARA) rules.

In some embodiments, the rules are for identifying shellcode.

In some embodiments, reducing the size of the preliminary set further includes, subsequently to removing those of the rules whose possible-false-positive counts exceed the respective predefined thresholds and paring the rules, removing, from the preliminary set, any one of the rules including all the conditions included in another one of the rules remaining in the preliminary set.

In some embodiments, reducing the size of the preliminary set further includes paring the rules in the preliminary set based on a degree to which each of the rules identified, as malicious, likely-malicious samples of the code-segment samples, which have a greater likelihood of being malicious relative to others of the code-segment samples.

In some embodiments, each of the likely-malicious samples is labeled as malicious or as probably malicious.

In some embodiments, the likely-malicious samples are associated with respective computing processes, and paring the rules based on the degree includes:
for each of the computing processes, identifying one or more of the rules that identified more of the likely-malicious samples associated with the computing process as malicious, relative to others of the rules; and
removing, from the preliminary set, any rule that was not identified for any of the computing processes.

In some embodiments, the likely-malicious samples are of respective types, and paring the rules based on the degree includes removing those of the rules for which those of the likely-malicious samples identified as malicious have less diversity with respect to the types, relative to others of the rules.

In some embodiments, paring the rules based on the degree includes:
computing respective per-type counts for the rules, each of the per-type counts being a number of the likely-malicious samples of a respective one of the types identified, by a respective one of the rules, as malicious;
adjusting the per-type counts, by setting any one of the per-type counts that is greater than a first predefined threshold to the first predefined threshold and/or setting any one of the per-type counts that is less than a second predefined threshold to a negative number;
computing respective sums of the adjusted per-type counts for the rules; and
removing those of the rules having smaller sums of the adjusted per-type counts, relative to others of the rules.

There is further provided, in accordance with some embodiments of the present invention, a computer software product including a tangible non-transitory computer-readable medium in which program instructions are stored. The instructions, when read by a processor, cause the processor to define a set of rules for identifying malicious code segments based on features of the code segments, by performing a process that includes applying a preliminary set of rules to multiple groups of code-segment samples having differing likelihoods of being malicious, each of the rules including one or more conditions on the features. The process further includes, for each one of the groups, computing respective counts for the rules, each of the counts being a number of the code-segment samples in the group that were identified, by a respective one of the rules, as malicious. The process further includes, for each of the rules, computing one or more possible-false-positive counts, which are respective numbers of samples belonging to respective subsets of the code-segment samples that were identified, by the rule, as malicious but have a lower likelihood of being malicious, relative to others of the code-segment samples. The process further includes reducing a size of the preliminary set, thereby defining the set, by removing, from the preliminary set, those of the rules for which at least one of the possible-false-positive counts exceeds a predefined threshold, and paring the rules in the preliminary set based on mutual similarity with respect to the conditions and the counts. The process further includes storing or communicating the set for use in identifying malicious code segments.

The present invention will be more fully understood from the following detailed description of embodiments thereof, taken together with the drawings, in which:

### BRIEF DESCRIPTION OF THE DRAWINGS

FIG. 1 is a schematic illustration of a system for identifying malicious code segments such as shellcode, in accordance with some embodiments of the present invention;

FIG. 2 is a schematic illustration of a method for defining rules, such as YARA rules, for identifying malicious code segments, in accordance with some embodiments of the present invention;

FIG. 3 is a flow diagram for a method for training a decision forest, in accordance with some embodiments of the present invention;

FIG. 4 is a flow diagram for a method for training multiple decision forests, in accordance with some embodiments of the present invention;

FIG. 5 is a schematic illustration of a decision forest constructed in accordance with some embodiments of the present invention;

FIG. 6 is a flow diagram for a method for tightening a rule for identifying malicious code segments, in accordance with some embodiments of the present invention; and

FIG. 7 is a flow diagram for a method for defining a set of rules for identifying malicious code segments based on features of the code segments, in accordance with some embodiments of the present invention.

### DETAILED DESCRIPTION

### Overview

In many applications, malicious code, such as shellcode, is identified using rules, such as YARA rules. Each rule includes one or more conditions on features of the code, whereby any code segment that satisfies each of the conditions is classified, by the rule, as a malicious code segment. For example, a rule may identify a segment of code as malicious based on the presence of one or more particular opcodes in the segment and/or the absence of one or more particular opcodes.

One conventional approach to defining such rules is manual analysis of malicious code samples. However, in addition to being labor intensive and prone to errors, this approach tends to yield rules that have poor recall and/or precision. Similarly, conventional machine-learning techniques are inappropriate, given that these techniques are difficult to apply to this problem (as is the case with neural networks, for example) and/or tend to yield rules that are not sufficiently robust.

Hence, embodiments of the present invention provide an alternative technique for automatically defining a set of rules for malicious code detection. Per this technique, multiple decision trees are trained on a training set of code segments, and a set of rules is then defined based on selected leaf nodes in the trees. During the training, features of the samples are successively removed from consideration, such that the rules are not overly dependent on a small set of dominant features. Thus, advantageously, the set of rules defined per this technique is effective and robust. By virtue of this successive removal of features, a collection of decision trees trained in accordance with some embodiments of the present invention may be referred to as a “subtraction forest.”

For example, in some embodiments, at least one decision forest of multiple decision trees is trained with a successive removal of features. For example, in some embodiments, the first decision tree in the first forest is trained on the full set of features in the training set. Subsequently, at least some of the features used by the first decision tree, such as those features that are most important to the first decision tree, are removed from the training set, and the second decision tree is then trained. Similarly, each additional decision tree is trained after additionally removing at least some of the features used by the previous decision tree, until the first decision forest is complete, e.g., until a predefined number of trees is reached.

Alternatively or additionally, multiple forests, each having one or more decision trees, are trained with a successive removal of features. For example, in some embodiments, subsequently to training the first decision forest, at least some of the features used by the first forest, such as those features that are most important to the first forest, are removed from the full set of features, and the first decision tree in the second decision forest is then trained on this reduced set of features. Subsequently, optionally, one or more additional decision trees are trained as described above for the first decision forest, until the second forest is complete, e.g., until a predefined number of trees is reached. Similarly, each additional decision forest is trained after additionally removing at least some of the features used by the previous forest.

Each decision tree has multiple leaf nodes, each of which is reached by following a respective path, through the tree, corresponding to a condition on the features. (It is noted that in the present specification, including the claims, a combination of conditions on different respective features may be described simply as a “condition” on the features, as in the sentence above. For example, a path through a decision tree corresponding to a first condition on a feature F1 and a second condition on a feature F2 may be said to correspond to a condition on the features F1 and F2.) Some of these leaf nodes are malicious-class leaf nodes, which are nodes for which any assigned code segment (i.e., any code segment satisfying the condition that leads to the node) is classified as malicious. In some embodiments, one or more malicious-class leaf nodes satisfying one or more predefined criteria, including, for example, a criterion based on the number of correct assignments (i.e., true positives), are identified in each decision forest. In some embodiments, a respective rule is then defined based on each condition corresponding to an identified malicious-class leaf node, and additional rules are defined by combining these conditions in various ways.

As a simple example, it will be assumed that the decision forest contains three decision trees, each having one identified malicious-class leaf node. It will further be assumed that one of the identified malicious-class leaf nodes classifies, as malicious, any code segment satisfying a first condition on a feature F1, another classifies, as malicious, any code segment satisfying a second condition on a feature F2, and another classifies, as malicious, any code segment satisfying a third condition on a feature F3. In this case, seven rules for identifying malicious code segments may be defined: one that identifies any code segment satisfying the first condition, another that identifies any code segment satisfying the second condition, another that identifies any code segment satisfying the third condition, another that identifies any code segment satisfying the first and second conditions, another that identifies any code segment satisfying the first and third conditions, another that identifies any code segment satisfying the second and third conditions, and another that identifies any code segment satisfying all three conditions.

In other embodiments, after training the first decision tree in the first decision forest on the full set of features in the training set, one or more malicious-class leaf nodes satisfying one or more predefined criteria, including, for example, a criterion based on the number of correct assignments, are identified. Another decision tree, in a second layer of the decision forest, is then “spawned” from each of the identified malicious-class leaf nodes. In particular, for each identified malicious-class leaf node, a decision tree is trained on the samples assigned to the leaf node (with additional benign samples if necessary), but without considering the features checked along the path to the leaf node. Subsequently, another decision tree is spawned from each identified malicious-class leaf node in this second level of the decision forest, i.e., for each of these nodes, a new decision tree is trained on the samples assigned to the node (with additional benign samples if necessary), but without considering the features checked along the path from the top of the first decision tree to the node. In this manner, successive levels of decision trees are trained, until the first decision forest is complete, e.g., until the forest includes a predefined number of levels.

In some such embodiments, subsequently to training the first decision forest, at least some of the features used by the first forest, such as those that are most important to the first forest, are removed from the full set of features, and the first decision tree in the second decision forest is then trained on this reduced set of features. Subsequently, successive layers of the second decision forest are spawned as described above for the first decision forest. Similarly, each additional decision forest is trained starting with a reduced set of features that includes all the original features except for at least some of the features used by the previous forests.

Subsequently, in each decision forest, those of the malicious-class leaf nodes that satisfy one or more predefined criteria, such as a criterion based on the number of true positives and/or a criterion based on the ratio of this number to the total number of samples assigned to the leaf node, are identified. A respective rule is then defined for each of the identified nodes, whereby the rule includes the condition corresponding to the path from the top of the first decision tree (at the first level of the forest) to the node.

As a simple example, it will be assumed that the first decision tree in the forest includes a leaf node that classifies, as malicious, any code segment satisfying a first condition on a feature F1. It will further be assumed that a second decision tree (at the second level of the forest) is spawned from this leaf node, and that this second tree includes two additional leaf nodes: one that classifies, as malicious, any code segment satisfying a second condition on a feature F2, and another that classifies, as malicious, any code segment satisfying a third condition on a feature F3 but not the second condition. It will further be assumed that each of these three leaf nodes satisfies the predefined criteria. In this case, three rules for identifying malicious code segments may be defined: one that identifies any code segment satisfying the first condition, another that identifies any code segment satisfying the first and second conditions, and another that identifies any code segment satisfying the first and third conditions but not the second condition.

Another challenge is that rules for identifying malicious code segments tend to return many false positives, i.e., tend to identify many benign code samples as malicious, when deployed in production. To address this challenge, some embodiments of the present invention provide a technique for tightening a rule, i.e., adding to the conditions of the rule, such that the rule returns fewer false positives. Advantageously, this technique does not significantly reduce the number of true positives returned by the rule.

In particular, to tighten a rule, a large number of code-segment samples, including, for example, a large number of unlabeled samples, is divided into two groups: a first group satisfying more of the conditions (e.g., all the conditions, or at least all the positive conditions on binary features) of the rule, and a second group satisfying less of the conditions. (One example of a binary feature is the presence or absence of a particular opcode; a positive condition on this feature corresponds to the presence of the opcode, and a negative condition corresponds to the absence of the opcode.) Subsequently, samples in the second group that are most similar to samples in the first group are identified. Next, features with respect to which the identified samples differ from the samples in the first group are identified. Finally, respective conditions on these identified features are added to the rule, such that the rule, even without its original conditions, would exclude at least some of the identified samples by virtue of the added conditions.

As a simple example, it will be assumed that the rule initially identifies, as malicious, any code segment having an opcode OC1, and that the identified samples differ from the samples of the first group by virtue of possessing a second opcode OC2. In this case, a negative condition on opcode OC2 may be added to the rule, such that the rule, after this tightening, identifies a code segment as malicious only if the segment does not have opcode OC2.

Another challenge is that a set of rules, whether generated as described above or generated using other techniques, may be impractically large and/or may contain redundancies. To address this challenge, some embodiments of the present invention provide a technique for reducing the size of a rule set, thereby eliminating redundancies without significantly reducing the recall of the set. It is noted that this process of reduction may also be referred to a “selection,” given that the rules that are not removed are selected for use in production.

In particular, the rules are applied to multiple groups of code-segment samples having differing likelihoods of being malicious. For example, the rule may be applied to a group of samples generated by an attack simulator, one or more groups of malicious samples from the training set, one or more groups of malicious samples from the testing set, a group of samples tagged by third-party software as malicious, a group of samples tagged by third-party software as benign, and/or a group of unlabeled samples. For each of the groups, respective counts are computed for the rules, each of the counts being the number of samples in the group that were identified, by a respective one of the rules, as malicious. For example, for a group of samples generated by an attack simulator, a first rule may have a count of 5 (indicating that five of the samples in the group were identified, by the rule, as malicious), a second rule may have a count of 15, etc.

Next, one or more possible-false-positive counts, which are respective numbers of samples belonging to respective subsets of the code-segment samples having a lower likelihood of being malicious that were identified, by the rule, as malicious, are computed for each of the rules. Typically, each subset including samples tagged as benign or as probably benign, and/or samples whose status is unknown (e.g., untagged samples). As a simple example, it will be assumed that a particular rule has a count of 10 for a group of benign samples and a count of 20 for a group of untagged samples. In this case, three possible subsets are (i) the first group, (ii) the second group, and (iii) the first and second groups. The corresponding possible-false-positive counts for the rule would be 10, 20, and 30, respectively.

Next, rules for which at least one of the possible-false-positive counts exceeds a predefined threshold are removed, thereby reducing the number of future false positives. For example, continuing the example above and assuming thresholds of X, Y, and Z for the three subsets, respectively, the rule may be removed if 10>X or 20>Y or 30>Z.

In addition, the rules are pared based on mutual similarity with respect to the conditions of the rules and the counts, thereby reducing redundancies. For example, given two rules with identical or similar conditions and identical or similar counts, one of the rules may be removed.

Alternatively to identifying malicious code, the techniques described herein may be used for other applications such as fraud detection, customer segmentation, credit scoring, and medical diagnoses.

### System Description

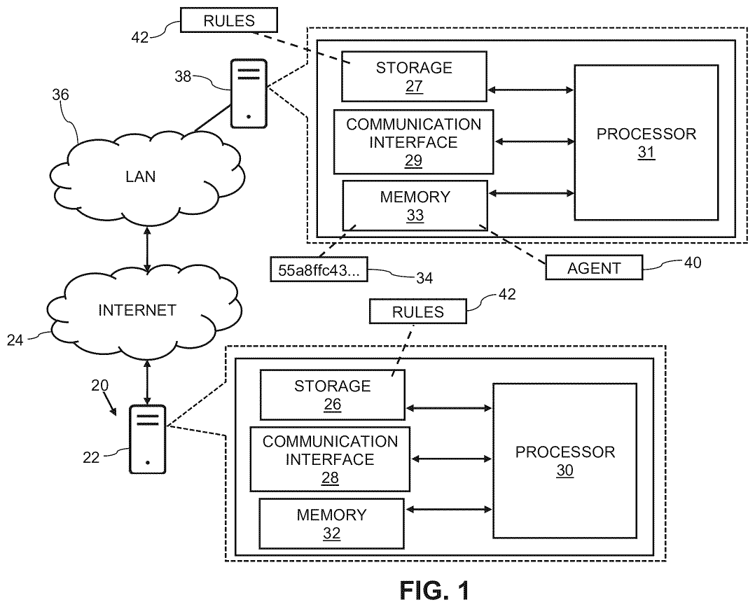

Reference is initially made to FIG. 1, which is a schematic illustration of a system 20 for identifying malicious code segments such as shellcode, in accordance with some embodiments of the present invention.

System 20 comprises at least one server 22, which in some embodiments belongs to a cloud-computing platform. Server 22 comprises a file storage 26, such as a hard drive or solid-state drive, a communication interface 28, a processor 30, and a memory 32, such as a random access memory. Memory 32 is configured to store program instructions for execution by processor 30. By executing the instructions, processor 30 learns rules 42 for identifying malicious code segments and/or performs the other functionality described below with reference to the subsequent figures. Processor 30 further stores rules 42 in memory 32 and/or storage 26, and/or communicates rules 42, using communication interface 28, over a computer network 24, such as the Internet.

For example, in some embodiments, server 22 communicates rules 42, over computer network 24, to one or more devices 38 connected to a local area network (LAN) 36. Typically, each device 38 comprises a file storage 27, such as a hard drive or solid-state drive, a communication interface 29, a processor 31, and a memory 33, such as a random access memory. Processor 31 is configured to receive rules 42 using communication interface 29, and to store the rules in memory 33 and/or storage 27. By applying the rules to code segments 34 loaded into memory 33, processor 31, by executing a software agent 40 (e.g., an antivirus agent), ascertains which of the code segments are likely malicious. In response to identifying a code segment that is likely malicious, processor 31 may generate an alert and/or take any remedial action.

Alternatively or additionally, processor 31 communicates suspicious code segments 34 to server 22 using communication interface 29, and processor 30 applies rules 42 to the code segments. In response to identifying a code segment that is likely malicious, processor 30 may generate an alert and/or take any remedial action. Alternatively or additionally, server 22 communicates the rules, and device 38 communicates suspicious code segments, to another server, such as a cloud server, configured to apply the rules to the segments.

Typically, each code segment is communicated together with metadata, which in some embodiments includes a description of the computing process with which the code segment is associated, i.e., the process being executed by the device while the code segment is in memory 33.

In some embodiments, code segments 34 include machine code, which can be represented in hexadecimal format as shown in FIG. 1. In some such embodiments, processor 31 (or processor 30) is further configured to convert the code segments to assembly code prior to applying rules 42 to the code segments. Alternatively or additionally, the processor applies at least some of rules 42 directly to the machine code.

By applying rules 42, the processor identifies malicious code segments based on features of the code segments. Typically, the features are tabular, i.e., the features can be organized in a structured format, as opposed to the non-tabular features used in other applications such as natural language or image processing. One type of feature is a binary feature, such as the presence or absence of a particular opcode or machine-code sequence in the code segment. Another type of feature is an integer, such as the number of instances of a particular opcode in the code segment. Another type of feature is a floating number, such a ratio of two such numbers of instances for different respective opcodes, or the entropy of the code segment. In some embodiments, the features vary depending on the type of code segment. For example, in some embodiments, the features of code segments belonging to a page allocation base address are different from those of code segments belonging to a thread start address.

In some embodiments, rules 42 are Yet Another Recursive Acronym (YARA) rules.

The definition of rules 42, which is performed by processor 30 or by another processor, is described in detail below with reference to the subsequent figures.

In general, each of the processors mentioned herein may be embodied as a single processor or as a cooperatively networked or clustered set of processors, e.g., in a cloud-computing platform. The functionality of each of the processors may be implemented solely in hardware, e.g., using one or more fixed-function or general-purpose integrated circuits, Application-Specific Integrated Circuits (ASICs), and/or Field-Programmable Gate Arrays (FPGAs). Alternatively, this functionality may be implemented at least partly in software. For example, the processor may be embodied as a programmed processor comprising, for example, a central processing unit (CPU) and/or a Graphics Processing Unit (GPU). Program code, including software programs, and/or data may be loaded for execution and processing by the CPU and/or GPU. The program code and/or data may be downloaded to the processor in electronic form, over a network, for example. Alternatively or additionally, the program code and/or data may be provided and/or stored on non-transitory tangible media, such as magnetic, optical, or electronic memory. Such program code and/or data, when provided to the processor, produce a machine or special-purpose computer, configured to perform the tasks described herein.

### DEFINING THE RULES

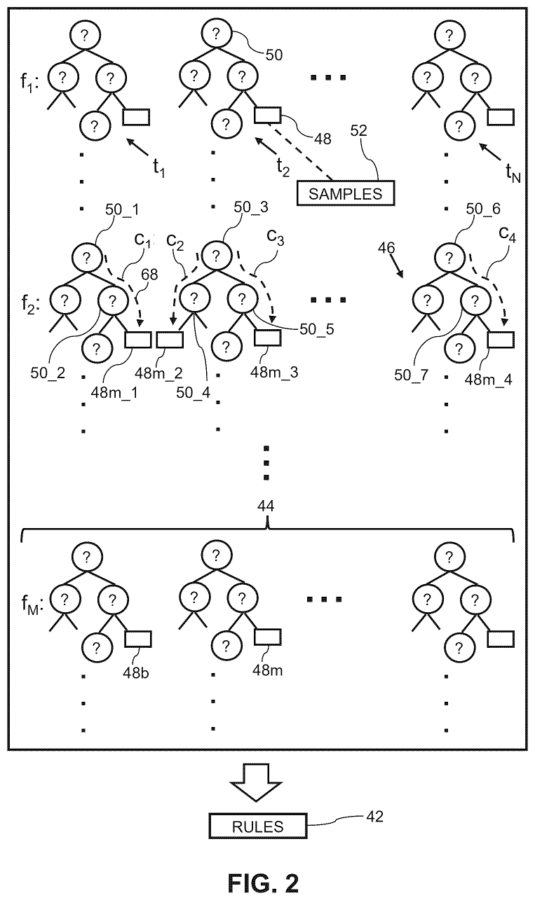

Reference is now made to FIG. 2, which is a schematic illustration of a method for defining rules 42, in accordance with some embodiments of the present invention.

In embodiments of the present invention, the processor trains multiple decision trees 46 on a training set of code-segment samples 52, some of which are malicious. Decision trees 46 include multiple decision nodes 50, each of which decides on one of two branches along which to route a sample 52 based on features of the sample. Decision trees 46 further include multiple leaf nodes 48 corresponding to different respective conditions on the features of the code segments, each of these conditions being a combination of the conditions defined by decision nodes 50 along the path 68 that leads to the leaf node 48. Leaf nodes 48 include one or more malicious-class leaf nodes 48m, which correspond to a malicious class such that any code segments assigned to malicious-class leaf nodes 48m are classified as malicious, and one or more benign-class leaf nodes 48b, which correspond to a benign class such that any code segments assigned to benign-class leaf nodes 48b are classified as benign.

In some embodiments, each decision tree 46 is a regression tree, in that each leaf node 48 corresponds to a different respective value of a score. In such embodiments, the malicious-class leaf nodes 48m correspond to the malicious class by virtue of corresponding to a predefined set of one or more values of the scores, and likewise for the benign-class leaf nodes. For example, considering a score that ranges between 0 and 1, where 0 corresponds to a minimal likelihood of maliciousness and 1 corresponds to a maximal likelihood of maliciousness, a malicious-class leaf node could be any leaf node corresponding to a score of more than a predefined threshold (e.g., 0.8). In other embodiments, each decision tree is a binary classification tree. The term “classification,” as used in the present specification, including the claims, is used to refer both to direct classification and to indirect classification via a regression score.

For each decision tree 46, samples 52 are assigned to the leaf nodes of the decision tree such that each sample assigned to any one of the leaf nodes satisfies the condition corresponding to the leaf node. For example, in a hypothetical decision tree 46, a leaf node might terminate the “no” (or “0”) branch of a decision node 50 that checks whether the code segment has a particular first opcode, which in turn terminates the “>5” branch of another decision node 50 that checks the number of instances of a second opcode in the code segment. In this case, the tree would assign, to this leaf node, any code segment that does not have the first opcode and has more than five instances of the second opcode. The leaf node could either be a malicious-class leaf node, in which case the assigned code-segment samples would be classified as malicious, or a benign-class leaf node, in which case the assigned code-segment samples would be classified as benign.

In some embodiments, the processor trains a single decision forest 44 of N>1 decision trees 46, designated herein as {t₁, . . . , t_{N}}. In other embodiments, the processor trains M>1 decision forests 44, designated herein by the notation {f₁, . . . , f_{M}}, each having one or more decision trees 46. It is noted that, in such embodiments, the decision forests do not necessarily have the same number of decision trees.

To train decision trees 46, the processor first trains the initial decision tree, i.e., t₁ in f₁. Subsequently to training the initial decision tree, the processor sequentially trains each additional decision tree while excluding, from the code-segment samples, at least some of the features used by (i.e., checked by decision nodes 50 in) those of the decision trees already trained. For example, after training t₁ in f₁, the processor may train t₂ in f₁ or t₁ in f₂ while excluding, from the code-segment samples, at least some of the features used by t₁ in f₁.

In some embodiments, within each decision forest 44 including multiple decision trees 46, the exclusion of features is cumulative. In other words, after training the first decision tree t₁ of the forest, the processor trains the subsequent decisions trees {t₂, . . . , t_{N}} of the forest, by, for k=2 . . . N, identifying a subset Rₖ₋₁ of the features that is used by tₖ₋₁, and training tₖ while excluding

$${⋃}_{j = 1}^{k - 1} {R}_{j}$$

(i.e., the union of {Rⱼ} for j=1 . . . k−1) from each of the code-segment samples. Thus, advantageously, the forest is trained so as not to be overly dependent on a small number of dominant features, such that the forest yields a robust set of rules that can catch malicious code based on a wide variety of features.

In some embodiments, the subset Rₖ₋₁ includes all the features used by tₖ₋₁. In other embodiments, the subset Rₖ₋₁ includes a random sampling of the features used by tₖ₋₁. In yet other embodiments, the processor identifies Rₖ₋₁ by identifying those of the features that are more important to tₖ₋₁ than are others of the features. For example, in some embodiments, the processor assigns, to Rₖ₋₁, any features for which a suitable measure of feature importance—which may be based, for example, on information gain, permutation methods, or Shapley Additive explanations—exceeds a predefined threshold, or a predefined number of features having the greatest importance with respect to the measure.

Alternatively or additionally, for embodiments in which multiple forests are trained, the exclusion of features is cumulative. In other words, after training f₁, the processor trains the subsequent forests {f₂, . . . , f_{M}} by, for i=2 . . . M, identifying a subset Qᵢ₋₁ of the features that is used by fᵢ₋₁, and training fᵢ while excluding

$${⋃}_{j = 1}^{i - 1} {Q}_{j}$$

from each of the code-segment samples.

In some such embodiments, the subset Qᵢ₋₁ includes all the features used by (i.e., checked by decision nodes in) fᵢ₋₁. In other embodiments, the subset Qᵢ₋₁ includes a random sampling of the features used by fᵢ₋₁. In yet other embodiments, the processor identifies Qᵢ₋₁ by identifying those of the features that are more important to fᵢ₋₁ than are others of the features. For example, in some embodiments, the processor assigns, to Qᵢ₋₁, any features for which a suitable measure of feature importance-which may be based, for example, on information gain, permutation methods, or Shapley Additive explanations-exceeds a predefined threshold, or a predefined number of features having the greatest importance with respect to the measure. Alternatively, the processor assigns, to Qᵢ₋₁, a predefined number of the features having greatest importance to each of the decision trees in fᵢ₋₁.

Thus, for example, in some embodiments, in training tₖ in fᵢ, the processor excludes

$${⋃}_{j = 1}^{i - 1} {Q}_{j}$$

and also

$${⋃}_{j = 1}^{k - 1} {R}_{j} ,$$

where each Rⱼ includes at least some of the features used by tⱼ in fᵢ.

The processor further identifies, from among the leaf nodes 48, one or more malicious-class leaf nodes 48m that satisfy at least one predefined criterion, referred to herein as “successful” leaf nodes. In some embodiments, the predefined criterion includes a minimum number of assigned malicious code-segment samples and/or a minimum percentage of assigned code-segment samples that are malicious. In other words, designating the number of malicious code-segment samples assigned to the node (i.e., the number of “true positives”) as TP and the number of benign code-segment samples assigned to the node (i.e., the number of “false positives”) as FP, the processor identifies the successful leaf nodes as those malicious-class leaf nodes 48m for which TP≥Y1 and/or TP/(TP+FP)≥X1, where X1 and Y1 are suitable predefined thresholds.

The processor further defines at least some of the rules 42 based on the conditions corresponding to the successful leaf nodes. Typically, for embodiments in which multiple forests are trained, the identification of the successful leaf nodes and the defining of rules based thereon is performed separately for each of the forests. In other words, for each one of the forests, the processor identifies the successful leaf nodes in the forest, and then defines one or more of the rules based on the conditions corresponding to the successful leaf nodes in the forest but not based on the conditions corresponding to the successful leaf nodes in any other one of the forests.

For example, for forest f₂, FIG. 2 shows:
(i) a malicious-class leaf node 48m_1 corresponding to a condition c₁, which is the combination of the conditions corresponding to the right branches of decision nodes 50_1 and 50_2;
(ii) a malicious-class leaf node 48m_2 corresponding to a condition c₂, which is the combination of the conditions corresponding to the left branches of decision nodes 50_3 and 50_4;
(iii) a malicious-class leaf node 48m_3 corresponding to a condition c₃, which is the combination of the conditions corresponding to the right branches of decision nodes 50_3 and 50_5; and
(iv) a malicious-class leaf node 48m_4 corresponding to a condition c₄, which is the combination of the conditions corresponding to the right branches of decision nodes 50_6 and 50_7.

Supposing that each of these four malicious-class leaf nodes is a successful leaf node, the processor would define one or more rules 42 based on c₁, c₂, c₃, and c₄.

For example, in some embodiments, for each forest, the processor identifies multiple different subsets of the conditions corresponding to the successful leaf nodes in the forest, each of the subsets including no more than one of the conditions from any given one of the decision trees in the forest. For each of the identified subsets, the processor defines a respective rule that includes all the conditions in the subset.

In some embodiments, the processor identifies all the subsets that include no more than one of the conditions from any given one of the decision trees in the forest. For example, supposing that f₂ includes only the three decision trees that are shown (i.e., that N=3 for f₂), the subsets that include no more than one of the conditions from any given one of the decision trees are {c₁}, {c₂}, {c₃}, {c₄}, {c₁, c₂}, {c₁, c₃}, {c₁, c₄}, {c₂, c₄}, {c₃, c₄}, {c₁, c₂, c₄}, and {c₁, c₃, c₄}. The processor may thus define a respective rule based on each of these subsets, for a total of eleven rules: one that identifies, as malicious, any code segment satisfying c₁, another that identifies, as malicious, any code segment satisfying c₂, another that identifies, as malicious, any code segment satisfying c₃, another that identifies, as malicious, any code segment satisfying c₄, another that identifies, as malicious, any code segment satisfying c₁ and c₂, etc.

In other embodiments, the processor identifies only those subsets having at least a predefined minimum number of conditions, only those subsets having no more than a predefined maximum number of conditions, or only those subsets having at least a predefined minimum number and also no more than a predefined maximum number of conditions. For example, supposing that f₂ includes only the three decision trees that are shown, the minimum number of conditions is two, and the maximum number of conditions is three, the processor may define seven rules based, respectively, on {c₁, c₂}, {c₁, c₃}, {c₁, c₄}, {c₂, c₄}, {c₃, c₄}, {c₁, c₂, c₄}, and {c₁, c₃, c₄}.

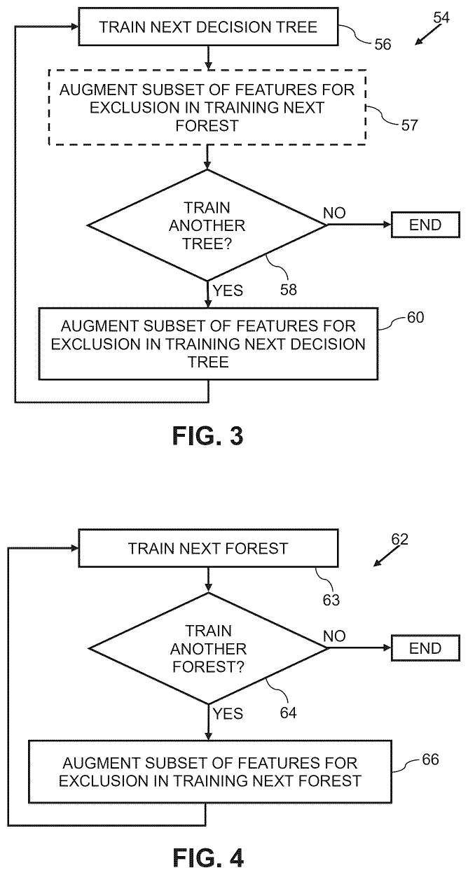

For more details regarding the training of each decision forest 44, reference is now made to FIG. 3, which is a flow diagram for a method 54 for training a decision forest, in accordance with some embodiments of the present invention.

Per method 54, the processor repeatedly trains a respective decision tree at a tree-training step 56. After each decision tree is trained, the processor performs an optional augmenting step 57. In particular, as described above with reference to FIG. 2, in some embodiments, the features to be excluded from the next decision forest include a predefined number of features having greatest importance to each decision tree in the present decision forest. In some such embodiments, the processor, at augmenting step 57, identifies the predefined number of features having the greatest importance to the decision tree trained at tree-training step 56, and then adds these features to the subset of features to be excluded in training the next forest.

Subsequently to augmenting step 57, or if augmenting step 57 is not performed, the processor decides, at a deciding step 58, whether to train another decision tree. If not, method 54 ends. Otherwise, at an augmenting step 60, the processor augments a subset of the features for exclusion in training the next decision tree. For example, in some embodiments, as described above with reference to FIG. 2, the processor identifies features that are more important to the decision tree than are others of the features, and then adds the identified features to the subset of features for exclusion. Alternatively, the processor randomly samples features used by the decision tree, or simply selects all the features used by the decision tree. Finally, the processor returns to tree-training step 56. Thus, the removal of features is cumulative, such that the features available for training tₖ, for k=2 . . . N, do not include any of the features added to the subset at augmenting step 60 when training t₁ . . . tₖ₋₁.

In some embodiments, at augmenting step 60, the processor augments the subset of features for exclusion with a predefined number X of features, such as the X features that are most important to the decision tree or X randomly-sampled features. In some such embodiments, at augmenting step 57, the predefined number of features added to the subset is X/p (rounded to an integer if necessary), where p is any suitable positive number greater than one, such as two.

In some embodiments, the processor, at deciding step 58, decides not to train another decision tree if a predefined target number of decision trees has been reached. Alternatively or additionally, the processor decides not to train another decision tree if the number of remaining features (i.e., the number of features not added to the subset at augmenting step 60) is less than a predefined threshold. Alternatively or additionally, the processor decides not to train another decision tree if the performance of the most-recently trained decision tree is below a performance threshold.

In some embodiments, the processor aborts the training of the forest if the performance of the first decision tree is below a performance threshold.

Reference is now made to FIG. 4, which is a flow diagram for a method 62 for training multiple decision forests, in accordance with some embodiments of the present invention.

Per method 62, the processor repeatedly trains a decision forest at a forest-training step 63, e.g., by executing method 54 described above with reference to FIG. 3. After each forest is trained, the processor decides, at a deciding step 64, whether to train another forest. If not, method 62 ends. Otherwise, at an augmenting step 66, the processor augments a subset of the features for exclusion in training the next forest. For example, in some embodiments, as described above with reference to FIG. 3, the processor augments the subset with the features collected at augmenting step 57. Alternatively, for example, the processor augments the subset with any other collection of features that are more important to the forest than are others of the features, a predefined number of randomly-sampled features, or all the features used by the forest. Finally, the processor returns to forest-training step 63. Thus, the removal of features is cumulative, such that the features available for training fᵢ, for i=2 . . . M, do not include any of the features added to the subset at augmenting step 66 when training f₁ . . . fᵢ₋₁.

In some embodiments, the processor, at deciding step 64, decides not to train another forest if a predefined target number of forests has been reached. Alternatively or additionally, the processor decides not to train another forest if the number of remaining features is less than a predefined threshold.

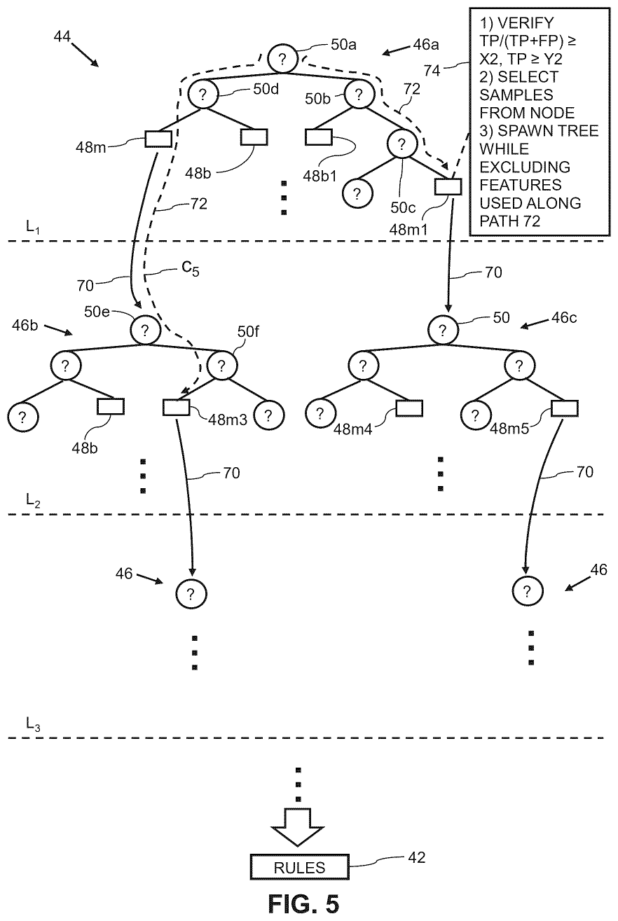

Reference is now made to FIG. 5, which is a schematic illustration of a decision forest 44 constructed in accordance with some embodiments of the present invention.

In some embodiments, each forest 44 has N≥2 levels, each having one or more decision trees 46. (N may vary between the forests.) To construct each forest 44, the processor trains an initial decision tree 46a at the first level L₁ of the forest. Subsequently, the processor builds each level Lₖ of the forest for k=2 . . . N, by spawning one or more additional decision trees in Lₖ from respective malicious-class leaf nodes 48m in Lₖ₋₁, as indicated in FIG. 5 by spawning indicators 70. In particular, the processor first identifies one or more malicious-class leaf nodes 48m in Lₖ₋₁ satisfying at least one predefined criterion. For each of the identified malicious-class leaf nodes, the processor selects a subset of the code-segment samples including at least some (e.g., all) of the malicious code-segment samples assigned to the node. Typically, the selected subset further includes at least some (e.g., all) of the benign code-segment samples assigned to the node. Finally, the processor spawns an additional decision tree 46 at Lₖ from the node, by training the additional decision tree on the subset of the code-segment samples while excluding, from each of the code-segment samples in the subset, those of the features used along the path 72 from the top of the initial decision tree to the node.

In some embodiments, the predefined criterion includes a minimum number of assigned malicious code-segment samples and/or a minimum percentage of assigned code-segment samples that are malicious. In other words, the processor identifies the malicious-class leaf nodes for which TP≥Y2 and/or TP/(TP+FP)≥X2, where Y2 and X2 are suitable predefined thresholds. Given that the number of samples decreases as the level number increases, in some embodiments, Y2 is a decreasing function of the level number.

By way of illustration, FIG. 5 shows two malicious-class leaf nodes in initial decision tree 46a, including a node 48m1. For each of these nodes, as shown in an inset portion 74 of the figure for node 48m1, the processor first checks whether the predefined criterion (assumed, in FIG. 5, to include both a minimum number and minimum percentage of assigned malicious code-segment samples) is satisfied. In response to verifying this, the processor selects at least some (e.g., all) of the samples from the node, and then spawns another decision tree at L₂ by training the tree on the selected samples while excluding the features used (i.e., checked at the decision nodes) along the path 72 from the top of the initial decision tree to the node. For example, in the case of node 48m1, the excluded features are those checked at the decision nodes 50a, 50b, and 50c. The processor thus adds decision trees 46b and 46c to L₂.

Similarly, FIG. 5 further shows malicious-class leaf nodes 48m3, 48m4, and 48m5 in L₂. Assuming that the predefined criteria are satisfied for nodes 48m3 and 48m5, the processor, for each of these two nodes, selects at least some (e.g., all) of the samples from the node, and then spawns another decision tree at L₃ by training the tree on the selected samples while excluding the features used along the path 72 from the top of initial decision tree 46a to the node. For example, in the case of node 48m3, the excluded features are those checked at the decision nodes 50a, 50d, 50e, and 50f.

In some embodiments, for cases in which the number of benign samples in the leaf node is insufficient for training another decision tree, the processor further selects, for the subset, one or more benign code-segment samples assigned to one or more leaf nodes that branch from path 72. Typically, in making this selection, the processor begins with the closest branch (i.e., the other branch from the decision node that is the immediate parent of the leaf node), and then progressively moves farther away as more benign samples are needed. Alternatively or additionally, the processor adds any other benign samples to the subset.

For example, supposing that the number of benign samples in node 48m1 is insufficient, the processor may select additional benign samples assigned to leaf nodes belonging to the left branch of decision node 50c. If the number is still insufficient, the processor may select additional benign samples from leaf node 48b1. If the number is still insufficient, the processor may select additional benign samples assigned to one or both of the leaf nodes belonging to the left branch of decision node 50a. Similarly, supposing that the number of benign samples in node 48m3 is insufficient, the processor may select additional benign samples assigned to one or more leaf nodes belonging to the right branch of decision node 50f. If the number is still insufficient, the processor may select additional benign samples assigned to one or more leaf nodes belonging to the left branch of decision node 50e. If the number is still insufficient, the processor may select additional benign samples assigned to leaf node 48b. If the number is still insufficient, the processor may select additional benign samples assigned to one or more leaf nodes belonging to the right branch of decision node 50a.

In some embodiments, the processor stops the construction of forest 44 in response to completing a target number of levels. Alternatively or additionally, the processor stops the construction of the forest in response to none of the malicious-class leaf nodes at the deepest (i.e., highest-number) level of the forest satisfying the criteria for spawning a new decision tree, none of these nodes that satisfy the criteria having a number of assigned malicious samples exceeding a predefined threshold, or none of these nodes that satisfy the criteria having a number of total assigned samples exceeding a predefined threshold.

Typically, for embodiments in which multiple forests 44 are trained, the processor successively removes features as each forest is trained, e.g., by executing method 62 (FIG. 4). In particular, after training the initial forest f₁, the processor trains {f₂, . . . , f_{M}} by, for i=2 . . . M, identifying a subset Qᵢ₋₁ of the features that is used by fᵢ₋₁, and then training fᵢ while excluding

$${⋃}_{j = 1}^{i - 1} {Q}_{j}$$

from each of the code-segment samples. In some embodiments, the processor assigns, to Qᵢ₋₁, all the features used by the top (i.e., lowest-number) K levels of fᵢ₋₁, i.e., levels L₁, . . . , L_{K} of fᵢ₋₁ for 1≤K≤N, N being the number of levels in fᵢ₋₁. In some such embodiments, K is a predefined integer; in other such embodiments, K is always equal to N. In other embodiments, the subset Qᵢ₋₁ includes a random sampling of the features used by the top K levels of fᵢ₋₁. In other embodiments, Qᵢ₋₁ includes the more important features used by fᵢ₋₁, such as (i) any features used by the top K levels of fᵢ₋₁ for which a suitable measure of feature importance—which may be based, for example, on information gain, permutation methods, or Shapley Additive explanations—exceeds a predefined threshold, (ii) a predefined number of features used by the top K levels of fᵢ₋₁ and having the greatest importance with respect to the measure, or (iii) a predefined number of the features having greatest importance to each of the decision trees in the top K levels of fᵢ₋₁.

Subsequently to constructing the forest(s), the processor defines rules 42. In particular, for each of the forests, for each node s of at least some of the malicious-class leaf nodes in {L₂, . . . , L_{N}} satisfying at least one predefined criterion (and hence, being a successful leaf node), the processor defines a respective one of the rules such that the rule includes the condition corresponding to the path from the top of the initial decision tree to s. In some embodiments, this predefined criterion includes a minimum number of assigned malicious code-segment samples and/or a minimum percentage of assigned code-segment samples that are malicious. In other words, in some embodiments, a successful leaf node is a malicious-class leaf node for which TP≥Y1 and/or TP/(TP+FP)≥X1. It is noted that this predefined criterion may be the same as or different from the predefined criterion for selecting malicious-class leaf nodes for spawning new decision trees. For example, in some embodiments, X1=X2 and Y1=Y2, whereas in other embodiments, X1≠X2 and/or Y1≠Y2.

For example, provided that node 48m3 is a successful leaf node, the processor defines a rule for node 48m3 including the condition c₅ corresponding to path 72 from the top of initial decision tree 46a to node 48m3.

In some embodiments, the processor also defines respective rules for successful leaf nodes in L₁, such that, altogether, the processor defines a respective rule for each successful leaf node in {L₁, . . . , L_{N}}.

### Tightening the Rules

In some embodiments, following the definition of rules 42 as described above or using any other suitable method, the rules are applied to (and thereby tested on) a testing set of code-segment samples. Those of the rules with sufficient recall (i.e., a sufficient number of true positives) and precision (i.e., a sufficiently small number of false positives) are selected, while the other rules are discarded. Optionally, each of the selected rules is then tightened, as described immediately below. Alternatively, the rules are not applied to a testing set, and each of the original rules is tightened.

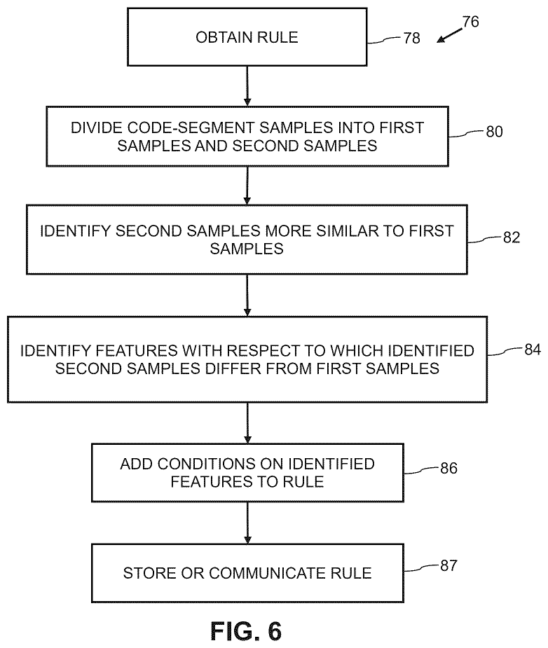

In the tightening process, one or more additional conditions are added to one or more of the rules, thereby reducing the number of false positives returned by the rules. In this regard, reference is now made to FIG. 6, which is a flow diagram for a method 76 for tightening a rule for identifying malicious code segments, in accordance with some embodiments of the present invention.

Method 76 begins with a rule-obtaining step 78, at which the processor obtains a rule for identifying malicious code segments. For example, in some embodiments, the processor defines the rule, e.g., as described above with reference to FIGS. 2-5. Alternatively, the processor receives the rule from another source. As explained above, the rule includes respective conditions on one or more features of the code segments.

After obtaining the rule, the processor, at a dividing step 80, divides multiple code-segment samples into first samples and second samples such that the conditions of the rule are satisfied more by the first samples than by the second samples. In some embodiments, the code-segment samples include a set of labeled code-segment samples—including, for example, at least part of the training set on which the rule was learned and/or at least part of the testing set on which the rule was tested—and/or a set of unlabeled code-segment samples. In some embodiments, the code-segment samples do not include benign-labeled samples (i.e., samples labeled as benign).

Typically, at least some of the code-segment samples are obtained, by the processor, from one or more software agents installed on devices 38 (FIG. 1), one or more firewalls, and/or other suitable sources in any one or more local networks. Typically, each of at least some of the samples is enriched with information such as the computing process with which the sample is associated, whether this process is signed by a trusted entity, the prevalence of the code contained in the sample, and/or any alerts that were triggered by the sample or by the process associated therewith. Based on this information, the processor may compute respective likelihoods for various labels (e.g., benign, malicious, probably benign, and probably malicious) for the sample, and then label the sample with the label having the greatest likelihood. For example, a sample signed by a trusted entity and/or containing prevalent code may be labeled as benign. Due to the typical lack of any human verification of the labels applied in this manner, and due to the fact that, in some embodiments, at least some of the samples remain unlabeled, the method for tightening the rules using these samples, as described herein, may be said to utilize a “semi-supervised approach.” (Notwithstanding the above, it is noted that in some embodiments, all the samples are human-labeled.)

For example, in some embodiments, the first samples include at least some of the code-segment samples identified, by the rule, as malicious (i.e., at least some of the code-segment samples satisfying all the conditions of the rule), and the second samples include at least some of the code-segment samples identified, by the rule, as benign (i.e., at least some of the code-segment samples that do not satisfy all the conditions of the rule). As a specific example, in some embodiments, the first samples include any unlabeled or malicious-labeled code-segment samples identified as malicious, and the second samples include any unlabeled code-segment samples identified as benign along with, optionally, any benign-labeled code-segment samples.

As another example, in some embodiments, the first samples include at least some of the code-segment samples satisfying all the positive conditions on binary features included in the rule, and the second samples include those of the code-segment samples that do not satisfy all the positive conditions. For example, supposing the rule identifies a code segment as malicious in response to the code segment possessing opcodes OC1 and OC2 but not possessing opcode OC3, the first samples may include unlabeled and malicious-labeled code-segment samples possessing opcodes OC1 and OC2 (regardless of whether they possess opcode OC3), and the second samples may include the code-segment samples not possessing OC1 or not possessing OC2 along with, optionally, any benign-labeled code-segment samples that possess both OC1 and OC2.

Next, the processor, at a samples-identifying step 82, identifies at least some of the second samples that are more similar to the first samples, relative to others of the second samples. As described below, the identified second samples are used to tighten the rule, thereby reducing the number of false positives returned by the rule.

For example, in some embodiments, the processor identifies at least some of the second samples that satisfy at least one of the positive conditions on the binary features included in the rule. For example, the processor may identify each unlabeled second sample that satisfies at least φU of the positive conditions and/or each benign-labeled second sample that satisfies at least φB of the positive conditions, φU and φB being predefined positive integers less than or equal to the total number of positive conditions. Alternatively, the processor may identify each second sample that satisfies at least φ of the positive conditions regardless of the labeling of the second sample, φ being a predefined positive integer less than or equal to the total number of positive conditions.

In some embodiments, the processor converts any non-binary features used by the rule to binary features. For example, one example of a non-binary feature is the number of instances of a particular opcode. Supposing that the rule includes a condition that this feature have a value greater than five, the processor may convert this feature to a binary feature that is true when the number of instances is greater than five and false otherwise. Advantageously, this conversion may facilitate the performance of dividing step 80 and/or samples-identifying step 82.

As the inventors have observed, typically, malicious code segments are distinguished from benign code segments more by code that they include, and less by code that they don't include. Hence, in some embodiments, as noted above, dividing step 80 and/or samples-identifying step 82 are based on the positive conditions of the rule.

Alternatively, in some embodiments, at samples-identifying step 82, the processor identifies at least some of the second samples whose distance from the first samples, per a distance measure, is less than a predefined threshold. For example, in some embodiments, assuming a set of P binary features, the processor may represent each code-segment sample by a vector of P elements, where each element is 1 or 0. Alternatively, the processor may project each such vector to a latent space having dimensionality less than P. The processor may then compute a single representative vector representing all the first samples, such as the average or median of the vectors representing the individual first samples. Subsequently, using a distance measure such as L1, L2, or cosine similarity, the processor may compute the distance between the representative vector and each of the second samples, and identify at least some of the second samples for which this distance is less than the threshold.

In some embodiments, at samples-identifying step 82, the processor first identifies a group of the second samples that are more similar to the first samples (e.g., based on the positive conditions or on a distance measure as described above), and then reduces the size of the group. As noted above, the identified second samples are used to tighten the rule, thereby reducing the number of false positives returned by the rule. However, if the rule is tightened too much, the number of true positives returned by the rule, when used in production, may also be reduced. Hence, advantageously, reducing the number of identified second samples helps maintain a balance between the recall and precision of the rule when used in production.

In some such embodiments, the processor reduces the size of the group by randomly sampling from the group.

In some embodiments, in performing this sampling, the processor pares more of the second samples that are less similar to the first samples, relative to the second samples that are more similar to the first samples. For example, it will be assumed that the identified group includes two subgroups having different respective degrees of similarity to the first samples: those of the second samples satisfying all but one of the positive conditions, and those of the second samples satisfying all but two of the positive conditions. In this case, given that the former subgroup is more similar to the first samples than is the latter subgroup, the processor may (i) randomly sample a predefined number of samples from the latter subgroup, and (ii) randomly sample a larger predefined number of samples from the former subgroup, or keep all of the former subgroup. In other embodiments, the processor randomly samples a predefined number of samples from the entire group, without regard to the different degrees of similarity to the first samples. In yet other embodiments, the processor randomly samples a predefined number of samples from each of the subgroups.

In some embodiments, the code-segment samples are associated with respective computing processes. In some such embodiments, to keep the approximate distribution of the identified second samples with respect to the computing processes, the processor divides the group of identified second samples into smaller groups, each of which includes second samples associated with a different respective one of the computing processes. Subsequently, the processor randomly samples from the smaller groups. Optionally, in performing the sampling from each of the smaller groups, the processor pares more of the second samples that are less similar to the first samples, as described above. Alternatively, the processor randomly samples a predefined number of samples from each of the smaller groups, without regard to the different levels of similarity to the first samples. Alternatively, the processor randomly samples a predefined number of samples from each of the subgroups (which have different respective degrees of similarity to the first samples) within each of the smaller groups.

Following samples-identifying step 82, the processor, at a features-identifying step 84, identifies one or more features with respect to which the identified second samples differ from the first samples. Subsequently, at a conditions-adding step 86, the processor adds respective conditions on the identified features to the rule, such that the rule, even without the original conditions included in the rule, would exclude at least some of the identified second samples by virtue of the added conditions.

In some embodiments, the processor identifies the features such that each of the first samples and, typically, each malicious-labeled sample erroneously classified, by the rule, as benign, satisfies the added conditions on the identified features. Thus, advantageously, the added conditions do not cause the rule to exclude any of the first samples or, typically, any of the misclassified malicious-labeled samples. Alternatively, for any one or both of these groups of samples, the processor requires only that a minimum percentage near 100% (e.g., 85%, 90%, or 95%) of the samples satisfies the added conditions on the identified features, thereby allowing a small number of the samples to be excluded by the added conditions. In some embodiments, the processor requires that a minimum percentage of any additional malicious-labeled samples that do not belong to the first or second samples also satisfies the added conditions on the identified features.

In some embodiments, the added conditions include respective negative conditions on binary features with respect to which the identified second samples differ from the first samples. For example, the processor may identify an opcode OC4 that is possessed by at least some of the identified second samples but is not possessed by any (or is possessed by only a few) of the first samples. In response thereto, the processor may add, to the rule, a negative condition on this opcode, such that the rule, even without the original conditions of the rule, would exclude at least some of the identified second samples by virtue of this added condition.

In some embodiments, at features-identifying step 84, the processor identifies the features using a maximum-coverage algorithm such as the algorithm described in Chvatal, Vasek, “A greedy heuristic for the set-covering problem,” Mathematics of operations research 4.3 (1979): 233-235, whose disclosure is incorporated herein by reference. Using such an algorithm, the processor may, for example, maximize the number of second samples that differ from the first samples with respect to the identified features, subject to a suitable constraint such as a maximum number of identified features. Alternatively, for example, the processor may minimize the number of identified features subject to a suitable constraint such as a minimum number of second samples that differ from the first samples with respect to the identified features.

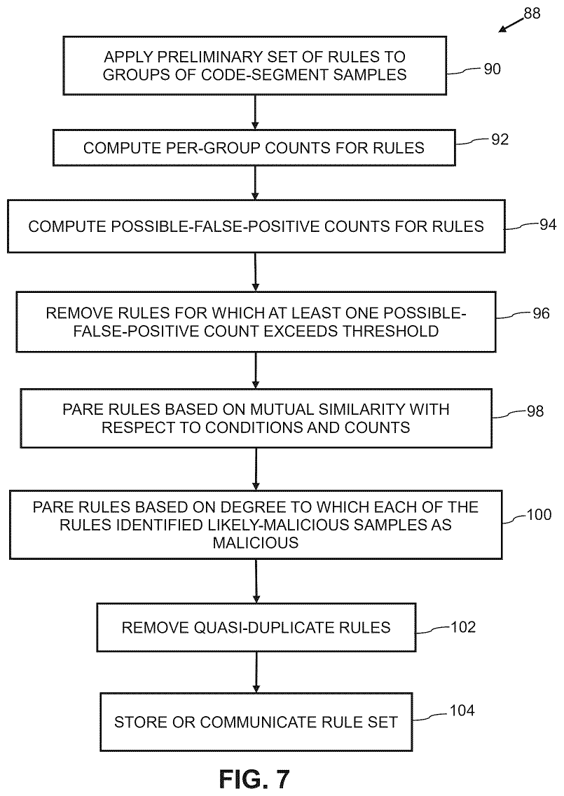

Finally, at a storing-or-communicating step 87, the processor stores or communicates the rule, as described above with reference to FIG. 1, for use in identifying malicious code segments. For example, for embodiments in which the number of rules is reduced as described below with reference to FIG. 7, the rule is stored in memory 32 or in storage 26 (FIG. 1). After all the rules are stored, the processor reduces the number of rules, and then stores or communicates the reduced set of rules.

Table 1 below shows a simplified example division of ten code-segment samples for a rule including positive conditions on binary features F1 and F2 and a negative condition on a binary feature F3, assuming that (i) the first samples include any unlabeled or malicious-labeled code-segment samples identified, by the rule, as malicious, and (ii) the second samples include any unlabeled code-segment samples identified, by the rule, as benign and any benign-labeled code-segment samples.

TABLE 1

| Sample | Label | First/Second | F1 | F2 | F3 | F4 | F5 |
|---|---|---|---|---|---|---|---|
| 1 | Malicious | First | 1 | 1 | 0 | 0 | 0 |
| 2 | Malicious | First | 1 | 1 | 0 | 0 | 0 |
| 3 | Malicious | N/A | 0 | 1 | 0 | 1 | 0 |
| 4 | Unlabeled | First | 1 | 1 | 0 | 1 | 0 |
| 5 | Unlabeled | First | 1 | 1 | 0 | 1 | 0 |
| 6 | Unlabeled | Second | 0 | 0 | 1 | 0 | 0 |
| 7 | Unlabeled | Second | 1 | 1 | 1 | 1 | 1 |
| 8 | Benign | Second | 0 | 0 | 1 | 0 | 1 |
| 9 | Benign | Second | 1 | 1 | 0 | 1 | 1 |
| 10 | Benign | Second | 1 | 1 | 1 | 1 | 1 |

In this example, the first samples include samples 1-2 and 4-5, given that each of these samples is malicious-labeled or unlabeled, has a value of 1 for each of F1 and F2, and has a value of 0 for F3. The second samples include samples 6-10. (It is noted that sample 9 is included in the second samples, despite the rule classifying this sample as malicious, due to this sample being labeled as benign.) Sample 3, which is labeled as malicious but is erroneously classified as benign by the rule, is included neither in the first samples nor in the second samples.

In this case, the processor may identify samples 7 and 9-10, each of which satisfies the positive conditions on F1 and F2, as being most similar to the first samples. Next, the processor may identify at least one feature on which to add a condition. In this case, binary features F4 and F5 have a value of 1 for each of samples 7 and 9-10 such that the processor could, hypothetically, add a negative condition on each of these features. However, feature F4 has a value of 1 for samples 4-5, which belong to the first samples, and sample 3, such that a negative condition on F4 would cause these samples to be classified as benign. Feature F5, on the other hand, has a value of 0 for each of samples 1-5. Hence, the processor may add a negative condition on feature F5 but not on F4, such that the modified rule includes positive conditions on F1 and F2 and negative conditions on F3 and F5.

### Reducing the Number of Rules

In some embodiments, following the definition of a preliminary set of rules 42 as described above with reference to FIGS. 2-5 or using any other suitable method, the processor reduces the size of the preliminary set (i.e., eliminates some of the rules), thereby defining a set of rules for use in production. This reduction or “paring” operation can be performed before or after the tightening described above, or without performing any tightening at all. In some embodiments, prior to the reduction operation, the rules are applied to a testing set as described above, and those rules without sufficient recall or precision are discarded.

In this regard, reference is now made to FIG. 7, which is a flow diagram for a method 88 for defining a set of rules for identifying malicious code segments based on features of the code segments, in accordance with some embodiments of the present invention.

Method 88 begins with a rule-applying step 90, at which the processor applies the preliminary set of rules to multiple groups of code-segment samples having differing likelihoods of being malicious. As described above, each of the rules includes one or more conditions on the features of the code segments.

In some embodiments, at least one of the groups is generated by at least one attack simulator, i.e., at least one of the groups includes malicious code-segment samples generated by at least one attack simulator. Alternatively or additionally, at least one of the groups includes code-segment samples tagged (or “labeled”) as malicious, e.g., by a third-party tool or based on public databases or behavioral indications. Alternatively or additionally, at least one of the groups includes code-segment samples tagged as benign, e.g., by a third-party tool or based on public databases or behavioral indications. For example, in some embodiments, multiple code-segment samples are tagged with respective tags corresponding to different respective likelihoods of maliciousness, and samples having identical or similar tags are then grouped together. Alternatively or additionally, the malicious code-segment samples from a training set used to learn the rules are grouped by family, whereby code-segment samples associated with the same computing process are considered to belong to the same family. Alternatively or additionally, the malicious code-segment samples from a testing set used to test the rules are grouped by family. Alternatively or additionally, at least one of the groups includes code-segment samples received from other sources in any one or more local networks, each of which may be unlabeled or automatically labeled based on enriching information, as described above with reference to FIG. 6. the method for reducing the number of rules using these samples, as described herein, may be said to utilize a “semi-supervised approach.”

Next, at a counts-computing step 92, the processor computes respective counts for the rules for each of the groups, each of the counts being the number of code-segment samples in the group that were identified, by a respective one of the rules, as malicious.

Subsequently, at another computing step 94, the processor computes, for each of the rules, one or more possible-false-positive counts, which are respective numbers of samples belonging to respective subsets of the code-segment samples that were identified, by the rule, as malicious but have a lower likelihood of being malicious relative to others of the code-segment samples. In some embodiments, at least one of the subsets includes those of the code-segment samples labeled as benign or as probably benign. Alternatively or additionally, one of the subsets includes those of the code-segment samples that are unlabeled. Typically, each of the subsets includes one or more of the groups, such that each of the possible-false-positive counts is equal to one of the counts or to a sum of two or more of the counts.

For example, it will be assumed that the groups include a group of code-segment samples tagged as benign and a group of untagged code-segment samples, and that the respective counts for these two groups, for a hypothetical rule, are w1 and w2, i.e., the rule identified w1 samples in the former group and w2 samples in the latter group as malicious. In this case, the processor can define a subset including only the former group, for which the possible-false-positive count is w1, a subset including only the latter group, for which the possible-false-positive count is w2, and/or a subset including both of these groups, for which the possible-false-positive count is w1+w2.

Subsequently, the processor reduces the size of the preliminary set, thereby defining the set.

In particular, at a rules-removing step 96, the processor removes, from the preliminary set, those of the rules for which at least one of the possible-false-positive counts exceeds a predefined threshold. For example, continuing the example above, the processor may remove those of the rules for which w1 exceeds a first threshold, those of the rules for which w2 exceeds a second threshold, and/or those of the rules for which w1+w2 exceeds a third threshold. Alternatively, for example, the processor may remove only those rules for which two of the thresholds are exceeded, or only those rules for which all three of the thresholds are exceeded.

Subsequently or prior to rules-removing step 96, the processor, at a paring step 98, pares the rules in the preliminary set based on mutual similarity with respect to the conditions on the features and the counts. In other words, the processor identifies each subset of the rules having similar conditions and counts, and then removes at least some of the rules, e.g., all but one of the rules, from each of these subsets.

In general, to ascertain whether any two rules are mutually similar (i.e., similar to one another), the processor may apply any suitable criteria.

For example, in some embodiments, the processor pares the rules based on mutual similarity with respect to the positive conditions on binary features. For example, in some embodiments, any two rules having an identical set of positive conditions, or a number of shared positive conditions exceeding a predefined threshold, are considered mutually similar with respect to the conditions of the rules. Alternatively or additionally, any two rules for which the percentage of positive conditions of one of the rules that are shared by the other one of the rules exceeds a predefined threshold are considered mutually similar with respect to the conditions.

As another example, in some embodiments, two rules are considered mutually similar with respect to the counts only if the rules have identical counts. Alternatively, for example, the two rules are considered mutually similar with respect to the counts if, for each of the groups, the difference between the counts (expressed as an absolute number or as a percentage of the number of samples in the group) is less than a predefined threshold. Alternatively, for example, the counts for each rule are expressed as vectors, and a clustering algorithm, such as density-based spatial clustering of applications with noise (DBSCAN) or ordering points to identify the clustering structure (OPTICS), is then applied to the vectors. Any rules belonging to the same cluster are then considered mutually similar with respect to the counts. For each of the above options, the processor may include all the counts or only a subset of the counts, i.e., the counts for only a subset of the groups.

In some embodiments, the processor leaves, in each subset, only the rule having the largest number of negative conditions on binary features or only the rule having the smallest number of negative conditions on binary features. Alternatively, the processor selects a rule at random from the subset. Alternatively, if one or more of the counts were not considered when assessing mutual similarity, the processor may perform a computation based on these counts, and then select a rule based on the result of the computation.

In some embodiments, reducing the size of the preliminary set further comprises another paring step 100, at which the processor pares the rules in the preliminary set based on the degree to which each of the rules identified, as malicious, those of the code-segment samples that have a greater likelihood of being malicious relative to others of the code-segment samples, referred to herein as “likely-malicious samples.” In some embodiments, each of the likely-malicious samples is labeled as malicious or as probably malicious. (In some embodiments, paring step 100 is performed before rules-removing step 96 and/or before paring step 98.)

For example, in some embodiments, for each computing process with which at least one likely-malicious sample is associated, i.e., for each family of likely-malicious samples, the processor identifies one or more rules that identified more of the likely-malicious samples associated with the computing process as malicious, relative to other rules. For example, in some embodiments, for each family of likely-malicious samples, the processor identifies the R1 best-performing rules, where R1 is any suitable predefined integer and the measure of performance is the number of samples in the family identified as malicious. The processor then removes, from the preliminary set, any rule that was not identified for any of the computing processes. Advantageously, this paring technique helps maintain the coverage of the rule set, i.e., does not overly decrease the recall of the remaining rules for each of the families.

Alternatively, in other embodiments, the processor removes, from the preliminary set, those of the rules for which those of the likely-malicious samples identified as malicious have less diversity with respect to the types of the samples, relative to others of the rules. In this context, “type” can be synonymous with “group” or can be defined in any other suitable way. For example, likely-malicious samples belonging to different families can be deemed to be of different types. Alternatively or additionally, likely-malicious samples belonging to the training set can be deemed to be of a different type from likely-malicious samples belonging to the testing set, and each of the above can be deemed to be of a different type from likely-malicious samples generated by an attack simulator. Advantageously, this paring technique helps maintain the diversity of the rule set, i.e., does not overly decrease the diversity of malicious code segments identified as malicious.

For example, in some embodiments, the processor computes (e.g., based on the counts) respective per-type counts for the rules, each of the per-type counts being the number of likely-malicious samples of a respective one of the types identified, by a respective one of the rules, as malicious. Subsequently, the processor adjusts the per-type counts, by setting any one of the per-type counts that is greater than a first predefined threshold to the first predefined threshold, and/or setting any one of the per-type counts that is less than a second predefined threshold to a negative number. (In some embodiments, different types have different respective thresholds.) Next, the processor computes the respective sums of the adjusted per-type counts for the rules (i.e., computes a sum of the adjusted per-type counts for each of the rules), and then removes those rules having smaller sums of the adjusted per-type counts, relative to other rules. For example, in some embodiments, the processor ranks the rules by their sums, and keeps only the top R2 rules, where R2 is any suitable predefined integer. Alternatively, the processor may remove any rule for which the sum is less than a predefined threshold.

For example, it will be assumed that for a particular rule, the respective counts for three groups of likely-malicious samples are 10, 50, and 3. It will further be assumed that these three groups are deemed to be of different respective types. In this case, for a first threshold of 5, the processor may compute adjusted per-type counts of 5, 5, and 3, such that the sum for the rule is 13. Alternatively, for a second threshold of 5 and assuming−5 for the negative number associated with the second threshold, the processor may compute adjusted per-type counts of 10, 50, and −5, such that the sum for the rule is 55. Alternatively, the processor may perform both adjustments, thereby computing adjusted per-type counts of 5, 5, and −5, such that the sum for the rule is 5.

In some embodiments, the processor also removes, from the preliminary set, any quasi-duplicate rules, i.e., any rule including all of the conditions included in another rule remaining in the preliminary set, at a deduplicating step 102. For example, supposing one rule includes positive conditions on features F1 and F2 and a negative condition on a feature F3, and another rule includes positive conditions on features F1 and F2 and no negative conditions, the processor would remove the former rule.

Finally, at a storing-or-communicating step 104, the processor stores or communicates the set of rules, as described above with reference to FIG. 1, for use in identifying malicious code segments.

In some embodiments, the processor converts any non-binary features referenced by the rules to binary features, as described above with reference to FIG. 6, to facilitate the performance of method 88.

Table 2 below shows a simplified example in which counts were computed for four groups of code-segment samples: a group of unlabeled samples, a group of samples labeled as probably malicious, a group of samples labeled as probably benign, and a group of malicious samples generated by an attack simulator.

TABLE 2

| | Features | Features | | | | Malicious |
|---|---|---|---|---|---|---|
| | with +ve | with −ve | | Probably | Probably | (attack |
| Rule | conditions | conditions | Unlabeled | malicious | benign | sim) |
| 1 | F1, F2 | F3 | 50 | 30 | 10 | 50 |
| 2 | F1, F2 | F4 | 48 | 32 | 11 | 51 |
| 3 | F1, F5 | F3, F4 | 10 | 5 | 2 | 15 |
| 4 | F1, F5 | F3, F6 | 10 | 6 | 2 | 15 |
| 5 | F5 | F6 | 70 | 10 | 20 | 10 |
| 6 | F2, F5 | F6 | 50 | 2 | 10 | 50 |

In this scenario, the processor may compute possible-false-positive counts for three subsets of the samples having a lower likelihood of being malicious, as shown in Table 3 below:

TABLE 3

| | Features | Features | | | Unlabeled + |
|---|---|---|---|---|---|
| | with +ve | with −ve | | Probably | Probably |
| Rule | conditions | conditions | Unlabeled | benign | benign |
| 1 | F1, F2 | F3 | 50 | 10 | 60 |
| 2 | F1, F2 | F4 | 48 | 11 | 59 |
| 3 | F1, F5 | F3, F4 | 10 | 2 | 12 |
| 4 | F1, F5 | F3, F6 | 10 | 2 | 12 |
| 5 | F5 | F6 | 70 | 20 | 90 |
| 6 | F2, F5 | F6 | 50 | 10 | 60 |

Next, assuming respective thresholds of 60, 25, and 80 for the three subsets, and further assuming that a rule is removed if any two of the thresholds are exceeded, the processor may remove Rule 5, given that 70>60 and 90>80.

Next, the processor may identify three subsets of mutually-similar rules: (i) Rule 1 and Rule 2, which have identical positive conditions and similar counts, (ii) Rule 3 and Rule 4, which have identical positive conditions and similar counts, and (iii) Rule 6. The processor may then randomly select Rule 1 from the first subset and Rule 3 from the second subset, thereby yielding three remaining rules: Rule 1, Rule 3, and Rule 6.

Next, assuming two types of likely-malicious samples—namely, the probably malicious samples and the simulated malicious samples—the processor may compute the per-type counts shown in Table 4 below. (Due to each type being identical to a respective group, the computation of the per-type counts is straightforward, in that each per-type count equals a respective one of the original counts)

TABLE 4

| | Features | Features | | Malicious |
|---|---|---|---|---|
| | with +ve | with −ve | Probably | (attack |
| Rule | conditions | conditions | malicious | sim) |
| 1 | F1, F2 | F3 | 30 | 50 |
| 3 | F1, F5 | F3, F4 | 5 | 15 |
| 6 | F2, F5 | F6 | 2 | 50 |

Next, the processor may pare the rules while maintaining diversity. For example, assuming a first (upper) threshold of 20, a second (lower) threshold of 5, and a negative number −5 associated with the second threshold, the processor may adjust the per-type counts, and then compute the sums of the adjusted per-type counts, as shown in Table 5 below:

TABLE 5

| | Features | Features | | Malicious | |
|---|---|---|---|---|---|
| | with +ve | with −ve | Probably | (attack | |
| Rule | conditions | conditions | malicious | sim) | Sum |
| 1 | F1, F2 | F3 | 30→20 | 50→20 | 40 |
| 3 | F1, F5 | F3, F4 | 5 | 15 | 20 |
| 6 | F2, F5 | F6 | 2→−5 | 50→20 | 15 |

Next, the processor may remove Rule 6, e.g., based on this rule having the smallest sum or based on the sum for this rule being less than a predefined threshold.

Next, the processor may check whether either of the remaining rules—namely, Rule 1 and Rule 3—is a quasi-duplicate. Given that this is not the case, the processor may retain both rules.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A system, comprising:
a memory configured to store program instructions for defining multiple rules for identifying malicious code segments based on features of the code segments; and
a processor configured to, by executing the program instructions:
train multiple decision trees, including an initial decision tree and one or more additional decision trees, on a training set of code-segment samples, some of which are malicious, the decision trees including multiple leaf nodes corresponding to different respective conditions on the features such that each of the code-segment samples assigned to any one of the leaf nodes satisfies the condition corresponding to the leaf node, by:
training the initial decision tree, and
subsequently to training the initial decision tree, sequentially training each additional decision tree while excluding, from the code-segment samples, at least some of the features used by those of the decision trees already trained,
identify, from among the leaf nodes, one or more malicious-class leaf nodes that correspond to a malicious class and satisfy at least one predefined criterion, and
define the rules based on the conditions corresponding to the identified malicious-class leaf nodes.

2. A method for defining multiple rules for identifying malicious code segments based on features of the code segments, the method comprising:
training multiple decision trees, including an initial decision tree and one or more additional decision trees, on a training set of code-segment samples, some of which are malicious, the decision trees including multiple leaf nodes corresponding to different respective conditions on the features such that each of the code-segment samples assigned to any one of the leaf nodes satisfies the condition corresponding to the leaf node, by:
training the initial decision tree, and
subsequently to training the initial decision tree, sequentially training each additional decision tree while excluding, from the code-segment samples, at least some of the features used by those of the decision trees already trained;
identifying, from among the leaf nodes, one or more malicious-class leaf nodes that correspond to a malicious class and satisfy at least one predefined criterion; and
defining the rules based on the conditions corresponding to the identified malicious-class leaf nodes.

3. The method according to claim 2, wherein the rules are Yet Another Recursive Acronym (YARA) rules.

4. The method according to claim 2, wherein the rules are for identifying shellcode.

5. The method according to claim 2, wherein the predefined criterion includes a minimum number of assigned malicious code-segment samples.

6. The method according to claim 2, wherein the predefined criterion includes a minimum percentage of assigned code-segment samples that are malicious.

7. The method according to claim 2, wherein training the decision trees comprises training at least one forest, which includes at least some of the decision trees, by:
training a first decision tree t₁ of the forest, and
training subsequent decisions trees {t₂, . . . , t_{N}} of the forest, by, for k=2 . . . N:
identifying a subset Rₖ₋₁ of the features that is used by tₖ₋₁, and
training tₖ while excluding
$${⋃}_{j = 1}^{k - 1} {R}_{j}$$
from each or the code-segment samples.

8. The method according to claim 7, wherein identifying the subset Rₖ₋₁ comprises identifying those of the features that are more important to tₖ₋₁ than are others of the features.

9. The method according to claim 7, wherein the subset Rₖ₋₁ of the features includes all the features used by tₖ₋₁.

10. The method according to claim 7, wherein defining the rules comprises:
identifying multiple different subsets of the conditions corresponding to those of the identified malicious-class leaf nodes in the forest, each of the subsets including no more than one of the conditions from any given one of the decision trees in the forest; and
for each of the subsets, defining a respective rule that includes all the conditions in the subset.

11. The method according to claim 2, wherein training the decision trees comprises training M>1 forests {f₁, . . . , f_{M}}, each of which includes one or more of the decision trees, by:
training f₁; and
for i=2 . . . M:
identifying a subset Qᵢ₋₁ of the features that is used by fᵢ₋₁, and
training fᵢ while excluding
$${⋃}_{j = 1}^{i - 1} {Q}_{j}$$
from each of the code-segment samples.

12. The method according to claim 11, wherein identifying the subset Qᵢ₋₁ comprises identifying those of the features that are more important to fᵢ₋₁ than are others of the features.

13. The method according to claim 11, wherein identifying the subset Qᵢ₋₁ comprises identifying a predefined number of the features having greatest importance to each of the decision trees in fᵢ₋₁.

14. The method according to claim 11, wherein identifying the malicious-class leaf nodes and defining the rules comprises, for each one of the forests:
identifying those of the malicious-class leaf nodes in the forest that satisfy the at least one predefined criterion; and
defining one or more of the rules based on the conditions corresponding to the identified malicious-class leaf nodes in the forest but not based on the conditions corresponding to the identified malicious-class leaf nodes in any other one of the forests.

15. A computer software product comprising a tangible non-transitory computer-readable medium in which program instructions are stored, which instructions, when read by a processor, cause the processor to define multiple rules for identifying malicious code segments based on features of the code segments, by:
training multiple decision trees, including an initial decision tree and one or more additional decision trees, on a training set of code-segment samples, some of which are malicious, the decision trees including multiple leaf nodes corresponding to different respective conditions on the features such that each of the code-segment samples assigned to any one of the leaf nodes satisfies the condition corresponding to the leaf node, by:
training the initial decision tree, and
subsequently to training the initial decision tree, sequentially training each additional decision tree while excluding, from the code-segment samples, at least some of the features used by those of the decision trees already trained,
identifying, from among the leaf nodes, one or more malicious-class leaf nodes that correspond to a malicious class and satisfy at least one predefined criterion, and
defining the rules based on the conditions corresponding to the identified malicious-class leaf nodes.

16. The computer software product according to claim 15, wherein the rules are Yet Another Recursive Acronym (YARA) rules.

17. The computer software product according to claim 15, wherein the rules are for identifying shellcode.

18. The computer software product according to claim 15, wherein the predefined criterion includes a minimum number of assigned malicious code-segment samples.

19. The computer software product according to claim 15, wherein the predefined criterion includes a minimum percentage of assigned code-segment samples that are malicious.

20. The computer software product according to claim 15, wherein training the decision trees includes training at least one forest, which includes at least some of the decision trees, by:
training a first decision tree t₁ of the forest, and
training subsequent decisions trees {t₂, . . . , t_{N}} of the forest, by, for k=2 . . . N:
identifying a subset Rₖ₋₁ of the features that is used by tₖ₋₁, and
training tₖ while excluding
$${⋃}_{j = 1}^{k - 1} {R}_{j}$$
from each of the code-segment samples.

21. The computer software product according to claim 20, wherein identifying the subset Rₖ₋₁ includes identifying those of the features that are more important to tₖ₋₁ than are others of the features.

22. The computer software product according to claim 20, wherein the subset Rₖ₋₁ of the features includes all the features used by tₖ₋₁.

23. The computer software product according to claim 20, wherein defining the rules includes:
identifying multiple different subsets of the conditions corresponding to those of the identified malicious-class leaf nodes in the forest, each of the subsets including no more than one of the conditions from any given one of the decision trees in the forest, and
for each of the subsets, defining a respective rule that includes all the conditions in the subset.

24. The computer software product according to claim 15, wherein training the decision trees includes training M>1 forests {f₁, . . . , f_{M}}, each of which includes one or more of the decision trees, by:
training f₁, and
for i=2 . . . M:
identifying a subset Qᵢ₋₁ of the features that is used by fᵢ₋₁, and
training fj while excluding
$${⋃}_{j = 1}^{i - 1} {Q}_{j}$$
from each of the code-segment samples.

25. The computer software product according to claim 24, wherein identifying the subset Qᵢ₋₁ includes identifying those of the features that are more important to fᵢ₋₁ than are others of the features.

26. The computer software product according to claim 24, wherein identifying the subset Qᵢ₋₁ includes identifying a predefined number of the features having greatest importance to each of the decision trees in fᵢ₋₁.

27. The computer software product according to claim 24, wherein identifying the malicious-class leaf nodes and defining the rules includes, for each one of the forests:
identifying those of the malicious-class leaf nodes in the forest that satisfy the at least one predefined criterion, and
defining one or more of the rules based on the conditions corresponding to the identified malicious-class leaf nodes in the forest but not based on the conditions corresponding to the identified malicious-class leaf nodes in any other one of the forests.
